(19) United States
(12) Patent Application Publication
(10) Pub. No.: US 2026/0162008 A1
(43) Pub. Date: Jun. 11, 2026

(54) TRAINING DEVICE AND METHOD FOR TRAINING CHEMICAL LANGUAGE MODEL FOR PREDICTING MOLECULAR PROPERTY

(71) Applicant: Korea University Research and Business Foundation, Seoul (KR)

(72) Inventors: Sang Keun LEE, Seoul (KR); Hyun-Tae PARK, Seoul (KR); Jun-Hyung PARK, Seoul (KR)

(21) Appl. No.: 19/275,775

(22) Filed: Jul. 21, 2025

(30) Foreign Application Priority Data
Dec. 5, 2024 (KR) 10-2024-0179964

(51) Int. Cl. G06N 20/00

(52) U.S. Cl. CPC G06N 20/00

(57) ABSTRACT

The present disclosure relates to a training device for training a chemical language model for predicting a molecular property, comprising: a mask for identifying and masking a substructure representing main features of a molecule in an input sequence in which the chemical structure of the molecule is expressed in a text form; a generator for training the chemical language model to restore an original token based on at least one token included in the masked substructure; and a discriminator for training the chemical language model to discriminate whether the token restored through the generator matches the original token.

### CROSS-REFERENCE TO RELATED APPLICATIONS

This application claims priority to Korean Patent Application No. 10-2024-0179964, filed on Dec. 5, 2024, in the Korean Intellectual Property Office, the disclosure of which is incorporated by reference herein in its entirety.

### TECHNICAL FIELD

The present disclosure relates generally to molecular property prediction, and more particularly, to a training device and method for training a chemical language model for predicting molecular property.

### BACKGROUND

Various fields, including drug development, material science, and environmental chemistry, play a significant role in the prediction of molecular properties. Existing methods for predicting physical properties mainly rely on an experimental approach, but this has a disadvantage that it takes a lot of time and has a significant cost. Accordingly, methods using computer simulation and machine learning techniques are being developed, and in particular, a deep learning-based approach is widely attracting attention due to its advantage in learning the complex characteristics of molecules and nonlinear relationships.

Recently, as a pre-learning language model such as Bidirectional encoder representations from transformers (BERT) has shown excellent performance in the field of Natural Language Processing (NLP), an attempt has been made to utilize a transformer-based architecture in a chemical language model. These models use a Simplified Molecular Input Line Entry System (SMILES) in which the structure of the molecule is expressed as text as input data, and are trained through Masked Language Modeling (MLM). MLM is a self-supervised learning technique that learns the contextual meaning of data through a process of restoring original data by masking a part of input data.

The SMILES-based chemical language model is trained and then used for various tasks such as predicting the properties of molecules through fine-tuning, predicting biological activity, and evaluating toxicity. This approach demonstrates the potential of deep learning in data-dependent chemistry research and complements the traditional computational chemistry methodology.

However, these existing chemical language models have limitations in that they do not sufficiently reflect the unique structural characteristics of chemical language expressions such as SMILES, as they borrow the learning method developed in the NLP field. SMILES expresses character structure as text, but unlike natural language, it is based on chemical structures and rules, not conceptual contexts or semantic relationships. For instance, special patterns like ring numbers and an unbalanced distribution of elements exist in SMILES. Such a pattern may result in the model being over-fitted to simple surface area rules or not sufficiently learning chemical information when trained in the conventional MLM method.

Therefore, applying the existing natural language-based prior learning method does not sufficiently reflect the complex characteristics of the molecular structure, which is a major factor limiting the performance of molecular characteristic prediction, so a learning method specialized for a chemical language model is needed.

### DISCLOSURE

Embodiments incorporating features of the present disclosure have been devised to address the above problems, and an object of the present disclosure is to provide a training device and method for training a chemical language model for predicting a molecular property.

According to an aspect of the present disclosure, there is provided a training device for training a chemical language model for predicting a molecular property, the training device including: a masking unit (or mask) configured to identify and mask a substructure representing a main feature of a molecule in an input sequence in which the chemical structure of the molecule is expressed in a text form; a generator configured to train the chemical language model to restore an original token based on at least one token included in the masked substructure; and a discriminator configured to train the chemical language model to discriminate whether the token restored through the generator matches the original token.

According to an aspect of the present disclosure, there is provided a method of training a chemical language model for predicting a molecular property, the method including: identifying and masking, by a masking unit, a substructure representing a main feature of a molecule in an input sequence in which the chemical structure of the molecule is expressed in a text form; training, by a generator, the chemical language model to reconstruct an original token based on at least one token included in the masked substructure; and training, by a discriminator, the chemical language model to discriminate whether the reconstructed token matches the original token.

### Advantageous Effects

According to an aspect of the present disclosure, by providing a training device and method for training a chemical language model for predicting a molecular property, it is possible to overcome limitations of a conventional SMILES-based model and greatly improve molecular property prediction performance.

In addition, by introducing learning through the generator and discriminator, surface pattern learning was reduced, overfitting was prevented even in large datasets to increase scalability, and external scientific literature embedding was used to deeply understand the characteristics of molecules.

### BRIEF DESCRIPTION OF DRAWINGS

FIG. 1 is a diagram illustrating an internal block of a training device for training a chemical language model for predicting molecular property according to an embodiment of the present disclosure.

FIG. 2 is a diagram for describing an operation in which the training device of FIG. 1 trains a chemical language model.

FIG. 3 is a flowchart illustrating a learning method of training method for training a chemical language model for predicting molecular property according to an embodiment of the present disclosure.

A detailed description of the present disclosure refers to the accompanying drawings, which illustrate specific embodiments in which embodiments may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein with respect to a particular embodiment may be implemented in other embodiments without departing from the spirit and scope of the present disclosure with respect to the particular embodiment. It should also be understood that the position or arrangement of individual components within each disclosed embodiment may be altered without departing from the spirit and scope of the present disclosure. Accordingly, the detailed description described herein is not intended to be taken in a limited sense, and the scope of the present disclosure is limited only by the appended claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present invention is not limited by the names of the components.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” or “unit” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Hereinafter, exemplary embodiments of the present disclosure will be described in more detail with reference to the drawings.

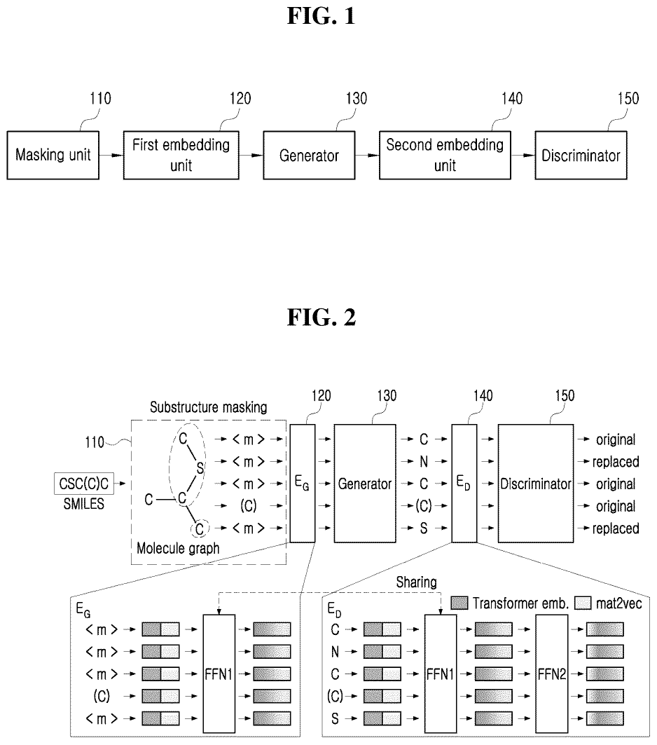

FIG. 1 is a device diagram illustrating an internal block of a training device for training a chemical language model for predicting molecular property according to an embodiment of the present invention, and FIG. 2 is a diagram for describing an operation in which the training device of FIG. 1 trains the chemical language model.

The illustrated device for training a chemical language model includes a masking unit (or mask) 110, a first embedding unit 120, a generator 130, a second embedding unit 140, and a discriminator 150.

The masking unit 110 identifies and masks a substructure representing the main characteristics of the molecule in an input sequence in which the chemical structure of the molecule is expressed in a text form. Here, the input sequence may be, for example, a Simplified Molecular Input Line Entry System (SMILES) sequence, and the substructure refers to a structural unit that determines important chemical properties in a molecule.

The generator 130 trains a chemical language model prepared in advance to restore an original token based on at least one token included in the substructure masked through the masking unit 110, and the discriminator 150 trains the chemical language model to discriminate whether the restored token matches the original token.

Meanwhile, the first embedding unit 120 converts tokens constituting the input sequence masked through the masking unit 110 into an embedding vector through a pre-prepared model, for example, a transformer model, and outputs the embedding vector to the generator 130.

In addition, the second embedding unit 140 converts tokens constituting the input sequence restored through the generator 130 into an embedding vector through a transformer model, and converts external information useful for predicting the properties of the molecule into an additional embedding vector through a pre-prepared model, for example, an mat2vec model.

Then, the second embedding unit 140 concatenates the embedding vector and the additional embedding vector and outputs the concatenated vector to the discriminator 150. Here, the mat2vec model is a pre-trained embedding model used to extract and embed meaningful chemical and material science-related information from external documents, for example, papers, patent documents, and other scientific documents. The weight of the mat2vec model is not updated during pre-training, and this is to maintain the knowledge that the mat2vec model has learned in an external document as it is.

Describing the operation of the training device of FIG. 1 in more detail with reference to FIG. 2 and formulas, the masking unit 110 may include input sequences X={x₁, x₂, x₃, . . . , xₙ} that identify a substructure and mask the token corresponding to the substructure, resulting in corrupted sequence \tilde{X}.

In this case, the masking unit 110 masks all special tokens representing structural information of molecules in the input sequence X, masks a substructure corresponding to at least one of a substituent, a bridge, and a continuous atom group, until the substructure does not exceed a predefined target masking ratio, and then randomly masks the remaining unmasked tokens in the input sequence X until the target masking ratio is reached.

The generator 130 is trained to restore the input sequence (original sequence) X using the parameter θ_{G}, and the loss function may be expressed as Equation 1 below.

$${L}_{G} = - {\sum }_{i ∈ M} log p ( {x}_{i} \vert \tilde{X} ; {θ}_{G} ) \qquad Equation 1$$

Here, M denotes a set of masked token locations, and p(xᵢ|\tilde{X};θ_{G}) denotes a probability of correctly predicting the i-th masked token xᵢ when receiving a corrupted sequence X as an input.

At this time, the masking unit 110 replaces some of the masked tokens with special masked tokens according to a predetermined ratio, replaces some of the masked tokens with random tokens, and masks some of the masked tokens by maintaining the original tokens as they are. In the present disclosure, it is assumed that 80% of the masked tokens are replaced with special masked tokens, 10% are replaced with random tokens, and 10% are maintained as they are.

That is, the generator 130 calculates a probability distribution for each of the masked tokens in the corrupted sequence \tilde{X}, and replaces each of the masked tokens with a token sampled in the corresponding probability distribution to generate an input sequence for the discriminator 150 as shown in Equation 2 below. Here, the sampling refers to a process of selecting one of the values predicted by the generator 130 to be restored.

$${\tilde{X}}_{D} = \{ \begin{matrix}\tilde{{x}_{ι}} ∼ p ( {x}_{i} \vert \tilde{X} ; {θ}_{G} ) & if i ∈ M \\ {x}_{i} & otherwise\end{matrix} \qquad Equation 2$$

The discriminator 150 is trained to distinguish whether each token of the input sequence \tilde{X}_{D} is an original token or a replaced token by using the parameter θ_{G}, and the loss function may be expressed as Equation 3 below.

$${L}_{D} = - {\sum }_{i = 1}^{n} log p ( {z}_{i} \vert {\tilde{X}}_{D} ; {θ}_{D} ) \qquad Equation 3$$

Here, zᵢ is a binary label indicating whether the i-th input token is an original token or a replaced token.

The final loss function may be expressed by combining the loss function of the generator 130 and the loss function of the discriminator 150 as shown in Equation 4 below.

$$L = {L}_{G} + λ {L}_{D} \qquad Equation 4$$

Here, λ is a hyperparameter that adjusts the balance between L_{G} and L_{D}.

The first embedding unit 120 may include an input sequence X={x₁, . . . , xₙ}, the embedding vector

$${E}^{t} = \{ {e}_{1}^{t} , … , {e}_{n}^{t} \} .$$

The second embedding unit 140 converts the external information useful for predicting a molecular property into an additional embedding vector

$${E}^{m} = \{ {e}_{1}^{m} , … , {e}_{n}^{m} \}$$

through mat2vec model, and combines E^{t} and E^{m} using Feed-Forward Networks (FFN), particularly a linear projection layer F1(⋅).

Accordingly, the embedding vector V_{G} for the generator 130 may be generated as in Equation 5 below.

$${V}_{G} = \{ {F}_{1} ( {e}_{1}^{t} ∘ {e}_{1}^{m} ) , … , {F}_{1} ( {e}_{n}^{t} ∘ {e}_{n}^{m} ) \} \qquad Equation 5$$

Here, º denotes a concatenation operation.

In a similar manner, the embedding vector V_{D} for the discriminator 150 may be generated from the token restored by the generator 130 as shown in Equation 6 below.

$$V = \{ {F}_{1} ( {e}_{1}^{∼ t} ∘ {e}_{1}^{∼ m} ) , … , {F}_{1} ( {e}_{n}^{∼ t} ∘ {e}_{n}^{∼ m} ) \} \qquad Equation 6$$

$${V}_{D} = \{ {F}_{2} ( σ ( {v}_{1} ) ) , … , {F}_{2} ( σ ( {v}_{n} ) ) \}$$

$$s . t . {v}_{1} , … , {v}_{n} ∈ V$$

Where v₁, . . . , vₙ∈V, and σ(⋅) denotes a Gaussian Error Linear Unit (GELU) function as an activation function.

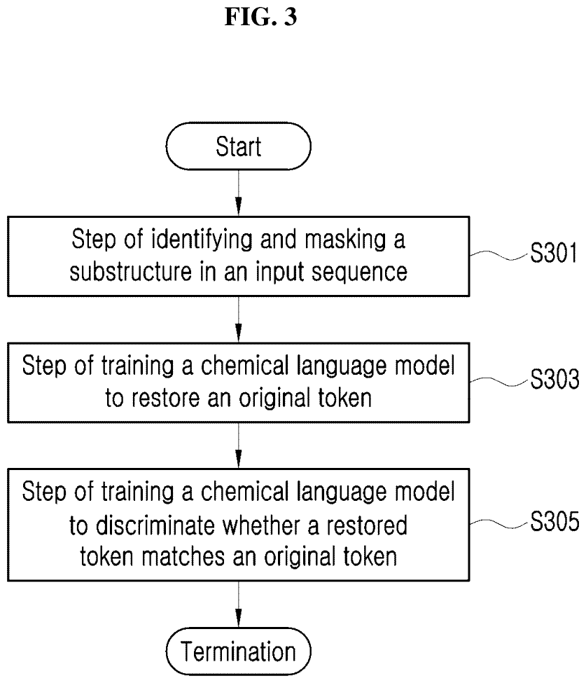

FIG. 3 is a flowchart illustrating a training method for training a chemical language model for predicting a molecular property according to an embodiment of the present invention.

The masking unit of the training device identifies and masks a substructure representing main characteristics of a molecule in an input sequence in which the chemical structure of the molecule is expressed in text form. (S301)

Then, the generator trains the chemical language model to restore the original token based on at least one token included in the substructure masked in the S301 (S303), and the discriminator trains the chemical language model to discriminate whether the restored token matches the original token. (S305)

The method for training a chemical language model for predicting molecular property of the present invention may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present invention or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present invention, and vice versa.

Although various embodiments of the present invention have been illustrated and described above, the present invention is not limited to the specific embodiments described above, and various modifications can be made by a person skilled in the art to which the present invention belongs without departing from the gist of the present invention claimed in the claims, and such modifications should not be individually understood from the technical spirit or the prospect of the present invention.

1. A training device for training a chemical language model for predicting a molecular property, the device comprising:
a mask configured to identify and mask a substructure representing a main feature of a molecule in an input sequence in which a chemical structure of the molecule is expressed in a text form, the input sequence including one or more tokens;
a generator configured to train the chemical language model to restore at least one original token of the input sequence based on at least one token included in the masked substructure; and
a discriminator configured to train the chemical language model to discriminate whether the at least one token restored through the generator matches the at least one original token of the input sequence.

2. The training device of claim 1, further comprising:
a first embedding circuit configured to convert the one or more tokens of the input sequence into a first embedding vector and output the first embedding vector to the generator; and
a second embedding circuit configured to convert the at least one original token of the input sequence restored through the generator into a second embedding vector, convert external information for predicting the properties of the molecule into a third embedding vector, and concatenate the second embedding vector and the third embedding vector into a concatenated result and output the concatenated result to the discriminator.

3. The training device of claim 1, wherein the mask masks all special tokens representing structural information of the molecule in the input sequence, masks a substructure corresponding to at least one of a substituent, a bridge, or a continuous atom group until the substructure does not exceed a predefined target masking ratio, and randomly masks remaining tokens that are not masked in the input sequence until the remaining tokens reach the predefined target masking ratio.

4. The training device of claim 1, wherein the mask is further configured to: replace some of the tokens of the masked substructure with special masked tokens, replace some of the tokens of the masked substructure with random tokens, and mask some of the tokens of the masked substructure by maintaining original tokens as they are according to a predetermined ratio.

5. The training device of claim 1, wherein the generator is further configured to generate a probability distribution for each of the tokens of the masked substructure, and replace each of the tokens of the masked substructure with a token sampled from the corresponding probability distribution.

6. A training method for training a chemical language model for predicting a molecular property, the method comprising:
identifying and masking, by a mask, a substructure representing a main feature of a molecule in an input sequence in which a chemical structure of the molecule is expressed in a text form, the input sequence including one or more tokens;
training, by a generator, the chemical language model to restore at least one original token of the input sequence based on at least one token included in the masked substructure; and
training, by a discriminator, the chemical language model to discriminate whether the at least one restored token matches the at least one original token of the input sequence.

7. The training method for training a chemical language model of claim 6, further comprising: converting, by a first embedding circuit, one or more tokens of the input sequence into a first embedding vector and outputting the embedding vector to the generator; and converting, by a second embedding circuit, tokens of the input sequence restored through the generator into a second embedding vector, converting external information useful for predicting the properties of the molecule into a third embedding vector, and concatenating the second embedding vector and the third embedding vector and outputting the additional embedding vector to the discriminator.

8. The training method for training a chemical language model of claim 6, wherein the masking comprises: masking all special tokens representing structural information of the molecule in the input sequence, then masking a substructure corresponding to at least one of a substituent, a bridge, or a sequential atom group until it does not exceed a predefined target masking ratio, and randomly masking remaining tokens that are not masked in the input sequence until it reaches the predefined target masking ratio.

9. The training method for training a chemical language model of claim 6, wherein the masking comprises: replacing some of the tokens of the masked substructure with special masked tokens, replacing some of the tokens of the masked substructure with random tokens, and masking some of the tokens of the masked substructure by maintaining original tokens as they are, according to a predetermined ratio.

10. The training method for training a chemical language model of claim 6, wherein the training of the chemical language model to restore the at least one original token comprises: generating a probability distribution for each of the tokens of the masked substructure, and replacing each of the tokens of the masked substructure with a token sampled from the corresponding probability distribution.
